(19) United States
(12) Patent Application Publication
(10) Pub. No.: US 2025/0273420 A1
(43) Pub. Date: Aug. 28, 2025

(54) X-RAY ROTATING ANODE WITH REDUCED EXTRAFOCAL X-RAY RADIATION

(71) Applicant: Siemens Healthineers AG, Forchheim (DE)

(72) Inventors: Nico JUNG, Bad Blankenburg (DE); Tobias HEINKE, Rudolstadt (DE); Lars FUHRMANN, Freiberg (DE); Bjoern OESTERREICHER, Saalfeld/Saale (DE)

(73) Assignee: Siemens Healthineers AG, Forchheim (DE)

(21) Appl. No.: 19/063,638

(22) Filed: Feb. 26, 2025

(30) Foreign Application Priority Data
Feb. 28, 2024 (DE) 20 2024 100 933.9

(51) Int. Cl. H01J 35/10; H01J 35/14; H01J 35/18

(52) U.S. Cl. CPC H01J 35/101; H01J 35/14; H01J 35/18; H01J 2235/18

(57) ABSTRACT

At least some example embodiments relate to an X-ray rotating anode, an X-ray tube and an X-ray emitter. The inventive X-ray rotating anode has a carrier including at least one of molybdenum or a molybdenum alloy; a first focal path on the carrier; and a second focal path on the carrier, wherein at least one of the first focal path or the second focal path comprises at least one of tungsten or rhenium, at least one of the first focal path or the second focal path are embodied on the carrier via a vacuum plasma spraying (VPS) coating method, and the first focal path and the second focal path are distanced from one another via an intermediate section in the carrier between the first focal path and the second focal path.

### CROSS-REFERENCE TO RELATED APPLICATION(S)

The present application claims priority under 35 U.S.C. § 119 to German Patent Application No. 20 2024 100 933.9, filed Feb. 28, 2024, the entire contents of which are incorporated herein by reference.

### FIELD

One or more example embodiments relates to an X-ray rotating anode, an X-ray tube and an X-ray emitter.

### RELATED ART

In X-ray tubes, electrons are accelerated by a cathode in the direction of an anode in order to generate X-ray radiation in a focal point. Anodes are regularly mounted in a rotatable manner in order to distribute heat introduced into the anode along a focal path upon interaction between the electrons. A higher dose rate can typically be achieved with such X-ray rotating anodes in the case of the primary X-ray radiation generated.

Extrafocal X-ray radiation originates from scattered electrons and/or electrons reflected onto the anode, in particular outside of, in particular in an environment of the focal spot or focal path. The extrafocal X-ray radiation has in particular comparable spectral properties such as the primary X-ray radiation. The extrafocal X-ray radiation may therefore result in an additional patient dose and/or image artifacts, in particular as a function of a collimation of the X-ray radiation. A typical image artifact is a shadow flicker, which reduces image quality. Typically the extrafocal X-ray radiation can be reduced by an additional filter, a collimation and/or by a geometric adjustment.

### SUMMARY

One or more example embodiments specifies an X-ray rotating anode, an X-ray tube and an X-ray emitter with reduced extrafocal X-ray radiation.

The object is achieved by the features of the independent claims. Advantageous embodiments are described in the subclaims.

Independent of the grammatical term usage, individuals with male, female or other gender identities are included within the term.

### BRIEF DESCRIPTION OF THE DRAWINGS

Example embodiments are described and explained in more detail below with the aid of the exemplary embodiments shown in the figures. Basically, structures and units which essentially remain the same are denoted with the same reference characters in the description of the figures below as with the initial occurrence of the respective structure or unit.

In the drawings:

FIG. 1 shows an inventive X-ray rotating anode according to one or more example embodiments,

FIG. 2 shows an X-ray rotating anode in a first exemplary embodiment,

FIG. 3 shows an X-ray rotating anode in a second exemplary embodiment,

FIG. 4 shows an X-ray rotating anode in a third exemplary embodiment,

FIG. 5 shows an X-ray rotating anode in a fourth exemplary embodiment,

FIG. 6 shows an X-ray rotating anode in a fifth exemplary embodiment,

FIG. 7 shows an inventive X-ray tube, and

FIG. 8 shows an inventive X-ray emitter according to one or more example embodiments.

### DETAILED DESCRIPTION

The inventive X-ray rotating anode has
a carrier comprising molybdenum and/or a molybdenum alloy,
a first focal path embodied on the carrier,
a second focal path embodied on the carrier,
wherein the first focal path and/or the second focal path comprises tungsten and/or rhenium,
   characterized in that
the first focal path and/or the second focal path are embodied on the carrier via a VPS coating method, and
the first focal path and the second focal path are distanced from one another by an intermediate section in the carrier between the first focal path and the second focal path.

According to one embodiment, the intermediate section comprises a web which is delimited on the one side by the first focal path and on the other side by the second focal path.

According to one embodiment, the intermediate section comprises a shaft, which is delimited on the one side by the first focal path and on the other side by the second focal path.

According to one embodiment, a lower side of the first focal path and a lower side of the second focal path is plane-parallel with respect to the surface of the intermediate section.

According to one embodiment, a surface of the carrier has a first groove and a second groove, wherein the first focal path is embodied within the first groove and the second focal path is embodied within the second groove.

According to one embodiment, the first focal path, the intermediate section and the second focal path are embodied plane-parallel to one another.

According to one embodiment, the first focal path, the intermediate section and the second focal path are embodied stepped with respect to one another.

According to one embodiment, the first focal path and the second focal path are embodied stepped with respect to the sections of the carrier plate which adjoin the first focal path and the second focal path.

According to one embodiment, the first focal path and the second focal path are embodied plane-parallel with respect to the sections of the carrier plate adjoining the first focal path and the second focal path.

According to one embodiment, the first focal path and the second focal path are embodied connected on the carrier in a shared manufacturing step and have thereupon been separated by the embodiment of the intermediate section.

An inventive X-ray tube has
an evacuated housing with an X-ray beam exit window,
an electron emitter and
an X-ray rotating anode,
wherein the electron emitter and the X-ray rotating anode are arranged within the evacuated housing.

According to one embodiment, the X-ray beam exit window is embodied to filter X-ray beams generated in the intermediate section.

According to one embodiment, the X-ray beam exit window has beryllium and/or titanium and/or aluminum for the filtering.

An inventive x-ray emitter has
an X-ray tube and
a filter unit for filtering X-ray beams generated in the intermediate section, which is arranged outside of the evacuated housing.

According to one embodiment, the filter unit has aluminum and/or titanium. Essentially the filter unit can also have beryllium.

By separating the first focal path and the second focal path via the intermediate section in the carrier, a region of the carrier which is free of molybdenum advantageously develops between the focal paths. The scattered or reflected electrons striking such a free region advantageously generate a displaced radiation spectrum compared with the radiation spectrum of the focal paths. An inventive advantage is therefore that the extrafocal X-ray radiation can be reduced significantly more easily via the energy displacement between the two radiation spectra. The image quality in particular is therefore increased and/or a number of image artifacts, in particular the negative influence caused by the shadow flicker of the extrafocal X-ray radiation, is reduced.

The reduction in the extrafocal X-ray radiation can take place for instance via filters, which are for instance part of the X-ray beam exit window of an X-ray tube with the X-ray rotating anode and/or arranged in addition. The filter can be in particular a beryllium, titanium and/or aluminum filter. Medical X-ray tubes in particular are regularly equipped as prescribed with an aluminum filter so that no additional outlay is required.

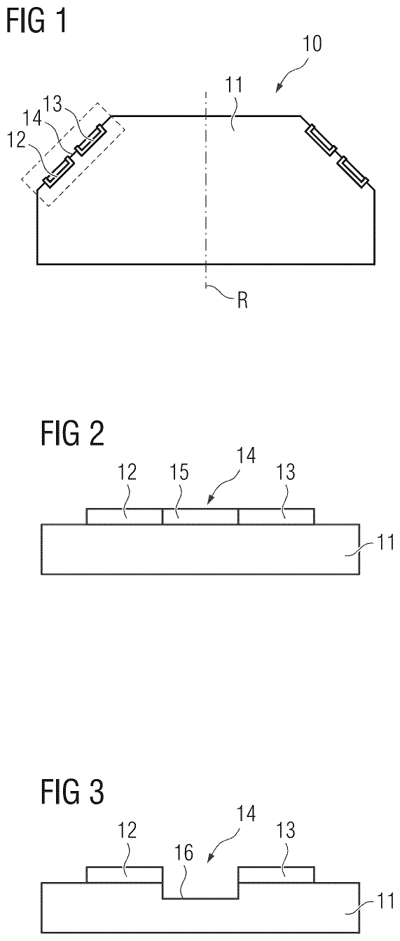

FIG. 1 shows an inventive X-ray rotating anode 10 in a diagram of a cross-sectional representation.

The X-ray rotating anode 10 has a carrier 11 made from molybdenum, preferably a molybdenum alloy, in particular TZM. The X-ray rotating anode 10 further has a first focal path 12 embodied on the carrier 11 and a second focal path 13 embodied on the carrier 11. The first focal path 12 and the second focal path 13 comprise tungsten, preferably combined with rhenium.

The first focal path 12 and preferably the second focal path 13 are embodied on the carrier 11 via a vacuum plasma spraying (VPS) coating method. The first focal path 12 and the second focal path 13 are distanced from one another by an intermediate section 14 in the carrier 11 between the first focal path 12 and the second focal path 13.

The first focal path 12 and the second focal path 13 have preferably been embodied in a non-connected manner on the carrier 11 in separate manufacturing steps. In this case, the intermediate section 14 can develop as a result for instance of the VPS coating method being carried out at a distance by way of the intermediate section 14 and/or masking the intermediate section 14.

Alternatively, the first focal path 12 and the second focal path 13 may have been embodied connected in a shared manufacturing step on the carrier 11 and thereupon separated by forming the intermediate section 14. The embodiment of the intermediate section 14 can comprise removing at least the VPS coating. The removal is carried out for instance via trimming and/or a laser method.

The X-ray rotating anode 10 is subsequently ground in particular after forming the first focal path 12 and the second focal path 13.

The carrier 11 is designed in particular to cool the first focal path 12 and/or the second focal path 13. The X-ray rotating anode 10 is embodied in a rotationally symmetrical manner and typically mounted in a rotatable manner about the axis of rotation R. In particular, the first focal path 12 and/or the second focal path 13 is thus likewise embodied to be rotationally symmetrical, preferably ring-shaped.

The intermediate section 14 is in particular free of the VPS coating. Advantageously the intermediate section has exclusively the material of the carrier 11. The intermediate section 14 has in particular the same material composition as the carrier 11.

The X-ray radiation generated via the X-ray rotating anode 10 is in particular a useful X-ray radiation and/or is suited to an imaging and/or therapeutic application. With imaging applications, a distinction is made between medical and non-medical application in particular. Medical applications are in particular computed tomography, mammography and/or angiography. Non-medical applications are in particular materials testing, a safety control and/or a customs audit.

The X-ray radiation generated in the intermediate section 14 is in particular an extrafocal X-ray radiation, which can be reduced in accordance with one or more example embodiments.

The cross-sectional representation diagram along the axis of rotation R further identifies a section outlined with a dashed line, which is shown in detail in FIGS. 2 to 6. On account of the rotational symmetry of the X-ray rotating anode 10, the first focal path 12, the second focal path 13, and the intermediate section 14 in their respective exemplary embodiment is designed to be identical, preferably angle-independently, as shown in this section.

FIG. 2 shows a detailed view of an inventive X-ray rotating anode 10 in a first exemplary embodiment.

The first exemplary embodiment is characterized in that the intermediate section 14 comprises a web 15, which is delimited on the one side by the first focal path 12 and on the other side by the second focal path 13. The web 15 is embodied in particular as part of the carrier 11. The web 15 has in particular the same material composition as the carrier 11. The height of the web 15 preferably amounts to at least the thickness of the first focal path 12 and the thickness of the second focal path 13.

The first focal path 12, the intermediate section 14 and the second focal path 13 are plane-parallel to one another. In respect of the sections of the carrier plate 11 adjoining the first focal path 12 and the second focal path 13, the first focal path 12 and the second focal path 13 are embodied in a stepped manner. These sections adjoining the first focal path 12 and the second focal path 13 frame in particular the first focal path 12, the second focal path 13 and the intermediate section 14 located therebetween.

FIG. 3 shows a detailed view of the inventive X-ray rotating anode 10 in a second exemplary embodiment.

The second exemplary embodiment is characterized in that the intermediate section 14 comprises a shaft 16, which is delimited on the one side by the first focal path 12 and on the other side by the second focal path 13. The base of the shaft 16 is deeper than a lower side of the first focal path 12 and a lower side of the second focal path 13. The shaft 16 can be formed in particular via an ablative method. The ablative method can be in particular a rotating and/or laser method. The shaft 16 is advantageously embodied to be deep so that the X-rays generated in the intermediate section 14 deplete within the shaft 16 on the shaft walls, for instance.

The first focal path 12, the intermediate section 14 and the second focal path 13 are embodied in a stepped manner with respect to one another. In respect of the sections of the carrier plate 11 adjoining the first focal path 12 and the second focal path 13, the first focal path 12 and the second focal path 13 are embodied in a stepped manner.

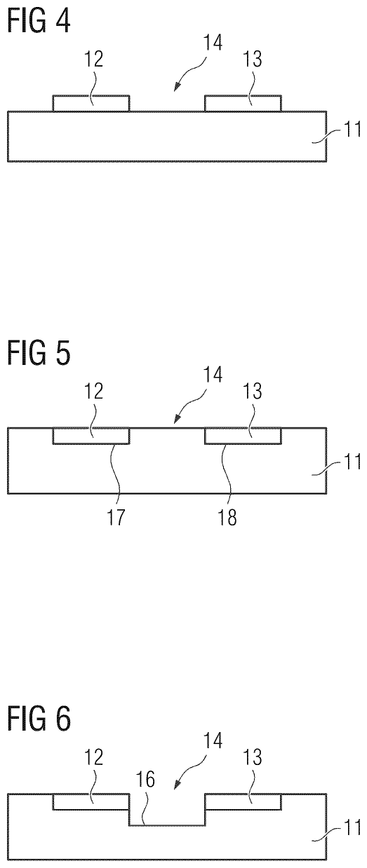

FIG. 4 shows a detailed view of the inventive X-ray rotating anode 10 in a third exemplary embodiment.

The third exemplary embodiment is characterized in that a lower side of the first focal path 12 and a lower side of the second focal path 13 is plane-parallel to the surface of the intermediate section 14. In this case, the surface of the intermediate section 14 corresponds in particular essentially to the original surface of the carrier 11, but has in particular no web 15 or shaft 16.

The first focal path 12, the intermediate section 14 and the second focal path 13 are embodied in a stepped manner with respect to one another. The first focal path 12 and the second focal path 13 are embodied in a stepped manner with respect to the sections of the carrier plate 11 adjoining the first focal path 12 and the second focal path 13.

FIG. 5 shows a detailed view of the inventive X-ray rotating anode 10 in a fourth exemplary embodiment.

The fourth exemplary embodiment is characterized in that a surface of the carrier 11 has a first groove 17 and a second groove 18. The first focal path 12 is embodied within the first groove 17 and the second focal path 13 is embodied within the second groove 18. The first groove 17 and the second groove 18 are filled in particular via the VPS coating method, in order to embody the first focal path 12 and the second focal path 13.

Alternatively, a surface of the carrier 11 can have a wide groove, wherein the first focal path 12 and the second focal path 13 are embodied within the first groove 17 and within the second groove 18 in each case, wherein the intermediate section 14 comprises a web 15, which is delimited on the one side by the first focal path 12 and on the other side by the second focal path 13, and is arranged within the wide groove between the first focal path 12 and the second focal path 13.

The first focal path 12, the intermediate section 14 and the second focal path 13 are embodied plane-parallel to one another. The first focal path 12 and the second focal path 13 are embodied plane-parallel in respect of the sections of the carrier plate 11 adjoining the first focal path 12 and the second focal path 13.

FIG. 6 shows a detailed view of the inventive X-ray rotating anode 10 in a fifth exemplary embodiment.

The fifth exemplary embodiment is characterized in that the intermediate section 14 comprises a shaft 16, which is delimited on the one side by the first focal path 12 and on the other side by the second focal path 13. The base of the shaft 16 is deeper than a lower side of the first focal path 12 and a lower side of the second focal path 13. The first focal path 12 and the second focal path 13 are embodied within a wide groove or within a first groove and a second groove in the surface of the carrier 11.

The first focal path 12, the intermediate section 14 and the second focal path 13 are embodied in a stepped manner with respect to one another. In respect of the sections of the carrier plate 11 adjoining the first focal path 12 and the second focal path 13, the first focal path 12 and the second focal path 13 are embodied plane-parallel.

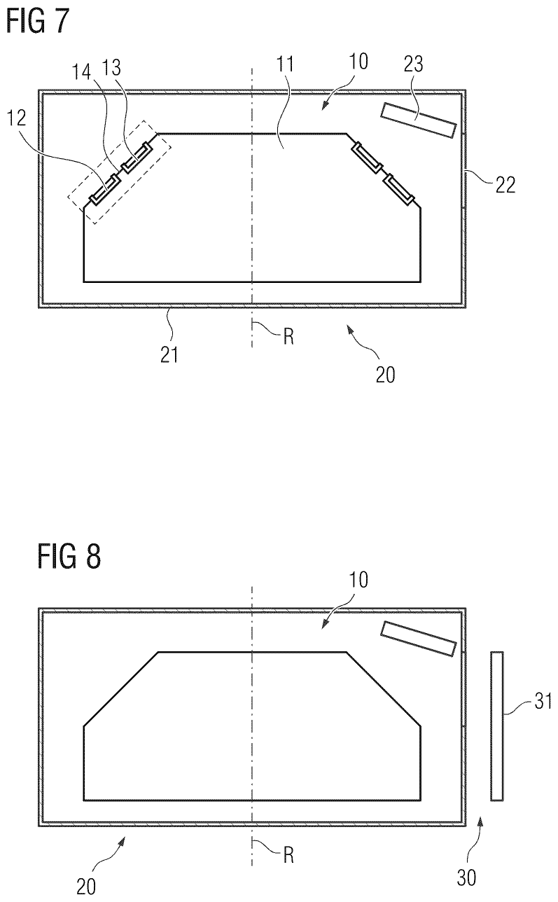

FIG. 7 shows an inventive X-ray tube 20 in a longitudinal section along the axis of rotation R.

The X-ray tube 20 has an evacuated housing 21 with an X-ray beam exit window 22, an electron emitter 23 and an X-ray rotating anode 10. The electron emitter 23 and the X-ray rotating anode 10 are arranged within the evacuated housing 21.

A section of the housing 21 can form the X-ray beam exit window 22. Alternatively, the X-ray beam exit window 22 can be distinguished structurally from the remaining housing 21 and inserted into the housing 21 in a vacuum-tight manner.

The electron emitter 23 is typically arranged above the first focal path 12 and the second focal path 14 on the cathode side. An acceleration voltage, via which the emitted electrons are accelerated in the direction of the X-ray rotating anode 10, lies in particular between the electron emitter 23 and the X-ray rotating anode 10.

The electron emitter 23 can be a thermionic emitter, for instance an emitter sheet or an emitter coil. Alternatively, the electron emitter 23 can be a field effect emitter, for instance made of silicon. The field effect emitter can have an emission surface with dimensions of such a type that electrons can be aligned with the first focal path 12 and/or the second focal path 13 without a deflection unit.

The electrons of the electron emitter 23 are preferably aligned so that they strike the first focal path 12 exclusively, the second focal path 13 exclusively or the first focal path 12 and the second focal path 13 simultaneously. The electrons can be aligned via a deflection unit.

The X-ray beam exit window 22 is preferably embodied to filter X-rays generated in the intermediate section 14. For this purpose, the X-ray beam exit window 22 can have beryllium and/or titanium and/or aluminum.

FIG. 8 shows an inventive X-ray emitter 30 in a longitudinal section along the axis of rotation R.

The X-ray emitter 30 has an X-ray tube 20 and a filter unit 31 for filtering X-rays generated in the intermediate section 14. The filter unit 31 is arranged outside of the evacuated housing 21. The filter unit 31 can be designed as a collimator, for instance. The filter unit 31 is arranged in particular in a beam path of the useful X-ray radiation so that the X-rays generated in the intermediate section 14 can be reduced.

The filter unit 31 can have in particular aluminum and/or titanium for the filtering. The filter unit 31 can be embodied in particular as a disk with a thickness of 2.5 mm made of aluminum.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the invention has been illustrated and described in more detail by the preferred exemplary embodiments, the invention is still not restricted by the disclosed examples, and other variations can be derived herefrom by the person skilled in the art without departing from the scope of protection of the invention.

1. An X-ray rotating anode, comprising:
a carrier including at least one of molybdenum or a molybdenum alloy;
a first focal path on the carrier; and
a second focal path on the carrier,
wherein at least one of the first focal path or the second focal path comprises at least one of tungsten or rhenium,
at least one of the first focal path or the second focal path are embodied on the carrier via a vacuum plasma spraying (VPS) coating method, and
the first focal path and the second focal path are distanced from one another via an intermediate section in the carrier between the first focal path and the second focal path.

2. The X-ray rotating anode of claim 1, wherein the intermediate section comprises a web, the web is delimited on one side by the first focal path and on another side by the second focal path.

3. The X-ray rotating anode of claim 1, wherein the intermediate section comprises a shaft, the shaft is delimited on one side by the first focal path and on another side by the second focal path.

4. The X-ray rotating anode of claim 1, wherein a lower side of the first focal path and a lower side of the second focal path are plane-parallel to a surface of the intermediate section.

5. The X-ray rotating anode of claim 1, wherein
a surface of the carrier has a first groove and a second groove, and
the first focal path is within the first groove and the second focal path is within the second groove.

6. The X-ray rotating anode of claim 1, wherein the first focal path, the intermediate section and the second focal path are plane-parallel with respect to one another.

7. The X-ray rotating anode of claim 1, wherein the first focal path, the intermediate section and the second focal path are stepped with respect to one another.

8. The X-ray rotating anode of claim 1, wherein the first focal path and the second focal path are stepped with respect to sections of the carrier adjoining the first focal path and the second focal path.

9. The X-ray rotating anode of claim 1, wherein the first focal path and the second focal path are plane-parallel with respect to sections of the carrier adjoining the first focal path and the second focal path.

10. The X-ray rotating anode of claim 1, wherein the first focal path and the second focal path are connected in a shared manufacturing step on the carrier and thereupon have been separated by the intermediate section.

11. An X-ray tube, comprising:
an evacuated housing with an X-ray beam exit window;
an electron emitter; and
the X-ray rotating anode of claim 1,
wherein the electron emitter and the X-ray rotating anode are within the evacuated housing.

12. The X-ray tube of claim 11, wherein the X-ray beam exit window is configured to filter X-rays generated in the intermediate section.

13. The X-ray tube of claim 12, wherein the X-ray beam exit window includes at least one of beryllium, titanium, or aluminum for the filtering.

14. An X-ray emitter, comprising:
the X-ray tube of claim 11; and
a filter unit configured to filter X-rays generated in the intermediate section, the intermediate section being outside of the evacuated housing.

15. The X-ray emitter of claim 14, wherein the filter unit includes at least one of aluminum or titanium.
